(19) United States
(12) Patent Application Publication
(10) Pub. No.: US 2010/0073234 A1
(43) Pub. Date: Mar. 25, 2010

(54) POSITIONING

(75) Inventors: Kimmo Kalliola, Helsinki (FI); Hannu Pekka Kauppinen, Helsinki (FI); Marion Hermersdorf, Lausanne (CH); Antti Paavo Tapani Kainulainen, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION, Espoo (FI)

(21) Appl. No.: 12/448,722

(22) PCT Filed: Dec. 28, 2007
(86) PCT No.: PCT/EP2007/011450

§ 371 Date: Nov. 18, 2009

Related U.S. Application Data
(63) Continuation-in-part of application No. 11/619,557, filed on Jan. 3, 2007.

(51) Int. Cl. G01S 1/68

(52) U.S. Cl. 342/386

(57) ABSTRACT

A system, including: an electrical network fitted to a building, for distributing electrical power within the building to make the building operational, the network comprising a plurality of nodes for outputting the electrical power each node comprising a receptacle for receiving a lighting element; and a plurality of radio devices, retrofitted to the operational building, wherein each of the radio devices is operable, when powered via a respective node of the network, to transmit data relating to positioning.

### FIELD OF THE INVENTION

Embodiments of the present invention relate to apparatus for use in positioning. In particular, they relate to positioning apparatus that is powered by an existing electrical distribution system of a building, a system comprising a plurality of apparatus and a method for providing the system.

### BACKGROUND TO THE INVENTION

It is often desirable to know the location of a person or device on a map or building plan. However, positioning systems for determining such a location may be expensive to set up and/or require the installation of a dedicated infrastructure.

For example, the installation of a positioning system in a building may require a dedicated network to be set up within the building, to supply electrical power to the radio transceivers of the system. It may also require a dedicated network to be set up for data exchange between the radio transceivers and/or a central computer.

The high cost and time requirements of installing such a positioning system act as a deterrent to providing the system.

### BRIEF DESCRIPTION OF THE INVENTION

According to one embodiment of the invention, there is provided a system, comprising: an electrical network fitted to a building, for distributing electrical power within the building to make the building operational, the network comprising a plurality of nodes for outputting the electrical power, each node comprising a receptacle for receiving a lighting element; and a plurality of radio devices, retrofitted to the operational building, wherein each of the radio devices is operable, when powered via a respective node of the network, to transmit data relating to positioning.

According to another embodiment of the invention, there is provided a method, comprising: retrofitting a plurality of radio devices to an operational building, the building having been made operational by fitting to the building an electrical network for distributing power within the building, the retrofitting including arranging the plurality of radio devices to be powered via nodes of the electrical network, wherein each node comprises a receptacle for receiving a lighting element.

A system is provided which uses an existing electrical power distribution network of a building to power a plurality of radio devices. Therefore, advantageously, the system is much cheaper to install than a system requiring its own dedicated power distribution network.

According to a further embodiment of the invention, there is provided an apparatus, comprising: an input power connector, having a first physical configuration, for coupling with an output power connector of a power supply having a second physical configuration, to receive electrical power; an output power connector, having the second physical configuration, for coupling with an input power connector of a further apparatus, to provide received electrical power to the further apparatus; and a radio transmitter operable, when the input power connector is coupled with the output power connector of the power supply, to transmit radio signals.

According to another embodiment of the invention, there is provided an apparatus, comprising: power input means, having a first physical configuration, for coupling with power output means of a power supply having a second physical configuration, to receive electrical power; power output means, having the second physical configuration, for coupling with power input means of a further apparatus, to provide received electrical power to the further apparatus; and means for transmitting radio signals when the power input means is coupled with the power output means of the power supply, to transmit radio signals.

Advantageously, the apparatus is able to receive electrical power to provide received electrical power to the further apparatus via an output power connector of the apparatus.

According to a further embodiment of the invention, there is provided a system, comprising: a lighting network fitted to a building, the lighting network having a plurality of lighting nodes, each lighting node comprising a connector for electrically connecting to a lighting element; and a plurality of radio devices, operable when powered via a respective lighting node of the lighting network, to transmit data relating to positioning.

According to another embodiment of the invention, there is provided a method, comprising: arranging a plurality of radio devices in a building to be to be powered via lighting nodes of a lighting network of the building, wherein each lighting node comprises a connector for electrically connecting to a lighting element.

According to a further embodiment of the invention, there is provided an apparatus, comprising: an input power connector, for coupling with an output power connector of a power supply, to receive electrical power; an output power connector, for coupling with an input power connector of a further apparatus, to provide received electrical power to the further apparatus; and a radio device operable, in response to receiving a radio signal, to enable the output power connector of the apparatus to provide received electrical power to the further apparatus.

The input power connector of the apparatus may have a first physical configuration and the output power connector of the power supply may have a second physical configuration.

The output power connector of the apparatus may have the second physical configuration. Alternatively, the output power connector may have a third physical configuration.

The apparatus may be a charger for charging a mobile telephone. The further apparatus may be a mobile telephone.

According to another embodiment of the invention, there is provided a charger for charging a mobile telephone, comprising: an input power connector, having a first physical configuration, for coupling with an output power connector of a power supply having a second physical configuration, to receive electrical power; an output power connector, having a third physical configuration, for coupling with an input power connector of a mobile telephone, to provide received electrical power to the mobile telephone; and a radio transmitter operable, when the input power connector is coupled with the output power connector of the power supply, to transmit radio signals.

### BRIEF DESCRIPTION OF THE DRAWINGS

For a better understanding of the present invention reference will now be made by way of example only to the accompanying drawings in which:

FIG. 1 illustrates a positioning system;

FIG. 2 illustrates first apparatus including a radio device;

FIG. 3 illustrates a second apparatus including a radio device;

FIG. 4 illustrates a radio device including a radio transmitter;

FIG. 5 illustrates a third apparatus including a radio device, where the radio device is configured to provide an input to an output power connector;

FIG. 6 illustrates a radio device including a radio receiver;

FIG. 7 illustrates a fourth apparatus including a battery; and

FIG. 8 illustrates a fifth apparatus including an energy collector.

### DETAILED DESCRIPTION OF EMBODIMENTS OF THE INVENTION

The Figures illustrate a system 100, comprising: an electrical network 150 fitted to a building 200, for distributing electrical power within the building 200 to make the building 200 operational, the network 150 comprising a plurality of nodes 101-106 for outputting the electrical power, each node 101-106 comprising a receptacle for receiving a lighting element; and a plurality of radio devices 20, retrofitted to the operational building 200, wherein each of the radio devices 20 is operable, when powered via a respective node 101-106 of the network 150, to transmit data 161 relating to positioning.

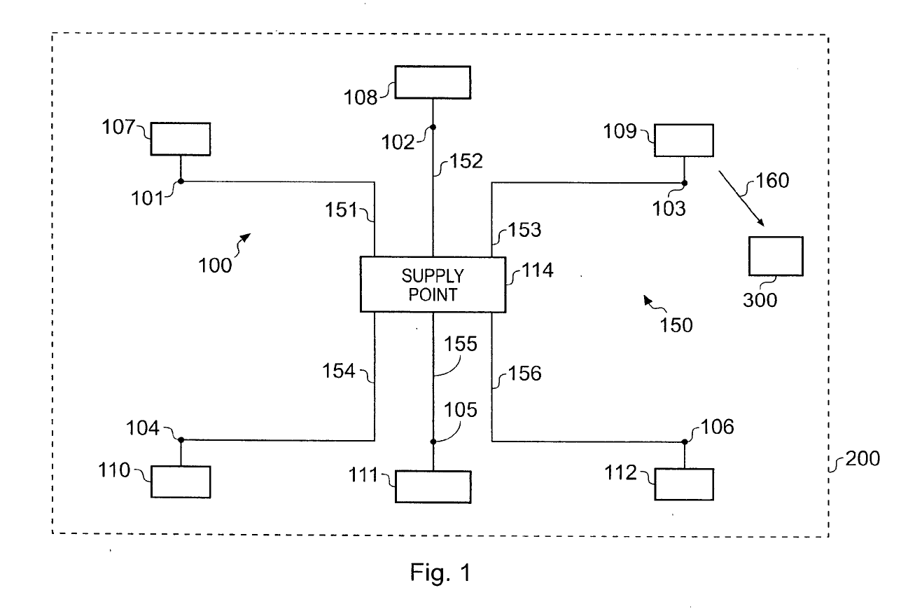

FIG. 1 illustrates a building 200 with an integrated network 150 for distributing electrical power around the building 200. The power distribution network 150 may be embedded within the fabric of the building. Mains/line/grid electrical power is supplied to the building at the supply point 114. The electrical power that is supplied to the supply point may, for example, be in the form of alternating current supplied at around at 110V (US and Japan) or 220-240V (Europe).

The supplied electrical power is distributed around the building 200 by the power distribution network 150. The power distribution network 150 includes a plurality of nodes 101-106 for outputting the distributed electrical power. Each of the output nodes 101-106 of the distribution network 150 may be in different rooms of the building. A single room may also have more than one output node 101-106.

When electrical power is distributed around the building 200 and available for output at nodes 101-106, the building is considered to be operational. When the building is operational it may, for example, be used as an office, a home or a shopping center.

It will be appreciated by the skilled reader that, for the purposes of explaining embodiments of the invention, the power distribution network 150 has been simplified. For example, in the power distribution network 150 illustrated in FIG. 1, each of the branches 151-156 of the power distribution network 150 emanate directly from the electrical supply point 114. In practice, some of the branches of the distribution network 150 may emanate from other branches.

FIG. 1 also illustrates a plurality of positioning apparatus 107-112 which are part of a positioning system 100. The positioning apparatus 107-112 are retrofitted to the operational building and are powered via the output nodes 101-106 of the power distribution network 150. That is, the retrofitted positioning apparatus 107-112 are fitted to the building 200 after it is deemed to be operational and are not embedded into the fabric of the building 200. The positioning apparatus 107-112 may be considered to be “added on” to the operational building 200.

It may be that the apparatus 107-112 are directly connected to the nodes 101-106 to receive electrical power. For example, some or all of the nodes 101-106 may comprise plug sockets, for receiving a standard two or three pin plug. Alternatively or additionally, some or all of the nodes may comprise light sockets for receiving lighting elements, such as light bulbs, fluorescent lighting tubes or LED lights. Alternatively or additionally, some or all of the nodes 101-106 may be for supplying power to smoke detectors.

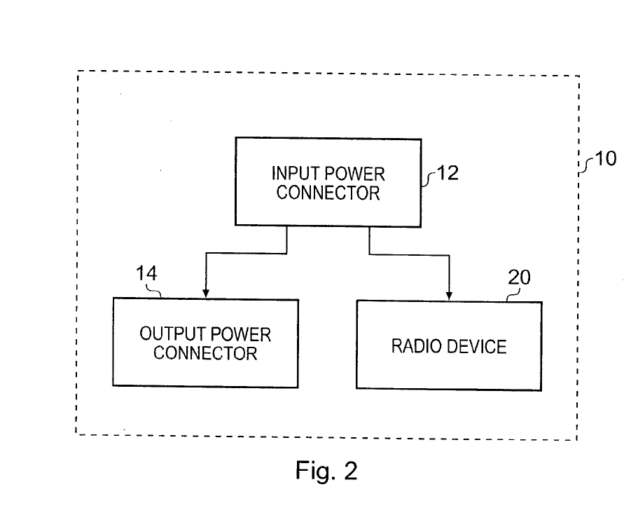

FIG. 2 illustrates one embodiment of an apparatus 107-112. This embodiment of an apparatus is represented by the reference numeral 10. The apparatus 10 comprises an input power connector 12, which is electrically connected to an output power connector 14 and a radio device 20. The apparatus 10 is small enough to be carried in the palm of a person's hand.

The input power connector 12 couples directly to an output power connector 14 at one of the nodes 101-106, to receive electrical power from the node 101-106. The coupling may be in the form of a male/female mating connection. For example, the output power connector of a node may comprise one or more receptacles for receiving one or more protruding members of the input connector 12 of the apparatus 10. Where a node is a plug socket for receiving a two pin-plug, the input power connector 12 is in the form of a two pin plug. Where the node is a light socket for receiving a lighting element, the input power connector 12 has the same form as the input power connector of a lighting element that connects to the output power connector of the node 101-106.

The output power connector 14 of the apparatus 10 may reproduce the output power connector of the node 101-106 to which the input power connector 12 is coupled. When an input power connector of a further apparatus/device is connected to the output power connector 14 of the apparatus, electrical power is distributed to the further apparatus to enable the further apparatus to function. If the output power connector of a node 101-106 is a light socket, the further apparatus may be a lighting element. Where the output power connector of a node 101-106 is a plug socket, the further apparatus could be anything that is operable to receive electrical power from a plug socket.

The input power connector 12 is also operable to supply received electrical power to the radio device 20, to enable the radio device 20 to function. The apparatus 10 may comprise a voltage reducer to reduce the voltage at the input connector 12 to a low voltage for providing to the radio device 20. A low voltage may be considered to be, for example, 3 volts or below. The apparatus 10 may also comprise a rectifier to convert the received alternating current to direct current, to provide to the radio device 20.

In some embodiments, the apparatus 10 may comprise an output power connector 14 which does not reproduce the output power connector of the node 101-106 to which the input power connector 12 is coupled. Instead, the output power connector 14 may take a different form. In this situation, the type of power that is distributed by the output power connector 14 of the apparatus 10 may be different to the type of power that is provided by the output nodes 101-106 of the power distribution network 150. For example, the apparatus 10 may supply power via the output power connector 14 that has been reduced by the voltage reducer and/or rectified by the rectifier.

For example, the apparatus 10 may be a charger for charging a battery of a portable electronic device such as a mobile telephone. One example of such a charger is a docking station. Alternating current of 110V (US and Japan) or 220-240V (Europe) may be provided to the charger by an output node 101-106 of the power distribution network 150, but the power that is provided by the output power connector 14 of the charger for supply to the battery of the portable electronic device may take the form of direct current at around 3-5V.

The output power connector 14 of the apparatus 10 may be removable and user-changeable. For example, where the apparatus is a charger for a mobile telephone, a user may select and attach the output power connector 14 that is appropriate for the particular type of portable electronic device that he wishes to connect to the charger.

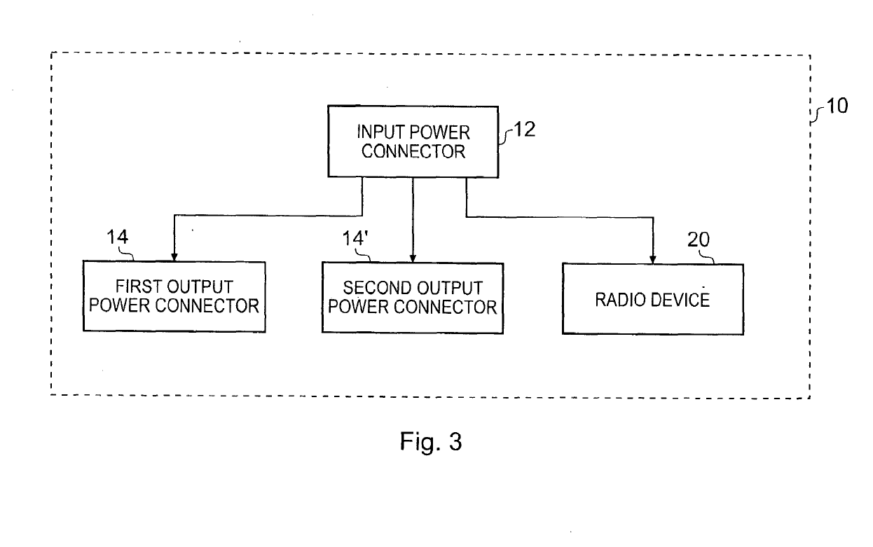

FIG. 3 illustrates an embodiment of the invention in which the apparatus 10 comprises a plurality of output power connectors 14, 14′. In this case, the output power connector 14 of the node 101-106 to which the input power connector 12 is coupled may be reproduced more than once by the apparatus 10. For example, the apparatus 10 may take the form of a power socket adapter in which the input power connector is a plug for connection to a plug socket, and each of the output power connectors 14, 14′ is a plug socket. The apparatus 10 may distribute electrical power to each further apparatus that is connected to a plug socket of the apparatus 10.

Advantageously, the apparatus 10 is able to receive power via the input power connector 12 to power the radio device 20, and is also able to distribute power to one or more further apparatuses by providing one or more output power connectors 14, 14′. In some embodiments, the apparatus 10 may reproduce the output power connector of a node 101-106 of the network 150 that it connects to. In such embodiments, the apparatus 10 may be considered to be parasitic in nature.

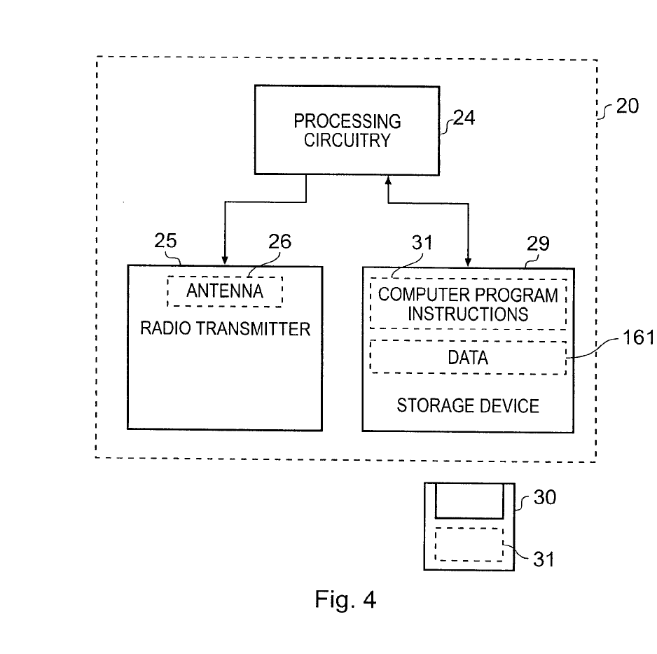

FIG. 4 illustrates an embodiment of the radio device 20 of the apparatus 10 in more detail. The radio device 20 comprises processing circuitry 24, a storage device 29 and a radio transmitter 25. In alternative embodiments, the radio device 20 may comprise a radio transceiver including a radio transmitter 25 and a radio receiver, rather than merely a radio transmitter 25. Subsequent references to a radio transmitter 25 should be understood as relating to a radio transmitter and to the radio transmitting aspect of a radio transceiver.

The processing circuitry 24 may be any type of processing circuitry. For example, it may be a programmable processor that interprets computer program instructions 31 and processes data. Alternatively, the processing circuitry 24 may be, for example, programmable hardware with embedded firmware. The processing circuitry 24 may be a single integrated circuit or a set of integrated circuits (i.e. a chipset). The processing circuitry 24 may also be a hardwired, application-specific integrated circuit (ASIC).

The processing circuitry 24 is connected to write to and read from the storage device 29. The storage device 29 is, in this example, operable to store computer program instructions 31 and data 161 relating to positioning. The data 161 relating to positioning may include an indication of the type of the radio device 20 and may include an identification code or address of the radio device 20. Either or both the computer program instructions 31 and the data 161 may be permanently stored in the storage device 29.

The storage device 29 may be a single memory unit or a plurality of memory units. If the storage device 29 comprises a plurality of memory units, part or the whole of the computer program instructions 31 may be stored in the same or different memory units. Also, some of the memory units may be read-only memory units.

The computer program instructions may arrive at the radio device 20 via an electromagnetic carrier signal or be copied from a physical entity 30 such as a computer program product, a memory device or a record medium such as a CD-ROM or DVD.

The processing circuitry 24 is operable to provide an output to the radio transmitter 25. The radio transmitter 25 comprises an antenna 26, and is operable to transmit radio frequency signals.

The radio frequency signals that the radio transmitter 25 is operable to transmit may be “low power” signals, such as those formulated according to the forthcoming Wibree specification. Further information regarding Wibree technology (formerly known as the Bluetooth Low End Extension) is described in Mauri Honkanen et al., “Low End Extension for Bluetooth” IEEE Radio and Wireless Conference RAWCON 2004, Atlanta, Ga., September, 2004, pages 19-22. The radio frequency signals may also be formulated according to specifications relating to UWB or Zigbee technologies.

For example, low power radio frequency signals may have a transmission range of 100 meters or less. Some low power radio frequency signals may have a transmission range of 10 meters or less.

The radio transmitter 25 may be operable to function as a radio beacon. For example, the radio transmitter 25 may transmit radio signals periodically (e.g. six times per second). The transmitted radio signal may include the data 161 relating to positioning stored in the storage device 29.

When the apparatus 10 comprises a radio receiver, the radio receiver may be operable to receive radio signals for wirelessly configuring the radio device 20. For example, the received radio signals may specify how often the radio transmitter is to transmit periodic radio signals.

In FIG. 1, an apparatus 109 is illustrated transmitting a radio signal 160 to a portable electronic device 300. The portable electronic device 300 may, for example, be operable as a mobile telephone. The radio signal 160 may include information identifying the radio device 20 of the apparatus 109, such as an identification code.

The portable electronic device 300 may be operable to receive a database relating to the plan of the building 200 from a remote server of a service provider. The database may be stored in a storage device of the portable electronic apparatus 300. The database may indicate where the apparatus 107-112 are located in the building by associating the identification code of an apparatus 107-112 with a particular position in the building 200.

If the transmission range of the apparatus 107-112 is known, reception of an identification code of an apparatus 107-112 enables the portable electronic device 300 to determine that its location is within the transmission range of the apparatus 107-112. If more than one identification code is received from the apparatus 107-112, the portable electronic device 300 determines that it is located in a region where the transmission ranges of the apparatus 107-112 corresponding to the received identification codes overlap. The received signal strength of the signal 160 may also be used by the portable electronic device 300 to determine its location.

In one embodiment, the database may associate each one of the apparatus 107-112 with a respective room in the building 200. If the portable electronic device 300 receives an identification code from an apparatus 107-112, the portable electronic device 300 is able to identify which room it is located in using the database.

In another embodiment, the database is stored at a remote server of a service provider and the portable electronic device 300 may transmit data relating to its position to the remote server, such as the identification code and the received signal strength of a signal received from an apparatus 107-112. The remote server may then determine the position of the portable electronic device 300 using the database and the information received from the portable electronic device 300.

The remote server may store the determined position, enabling the user of the portable electronic device 300 and/or third parties (e.g. the emergency services) to locate the portable electronic device 300 by accessing the stored position at the remote server. Additionally or alternatively, details of the determined position may be transmitted by the service provider to the portable electronic device 300 and/or a device of a third party.

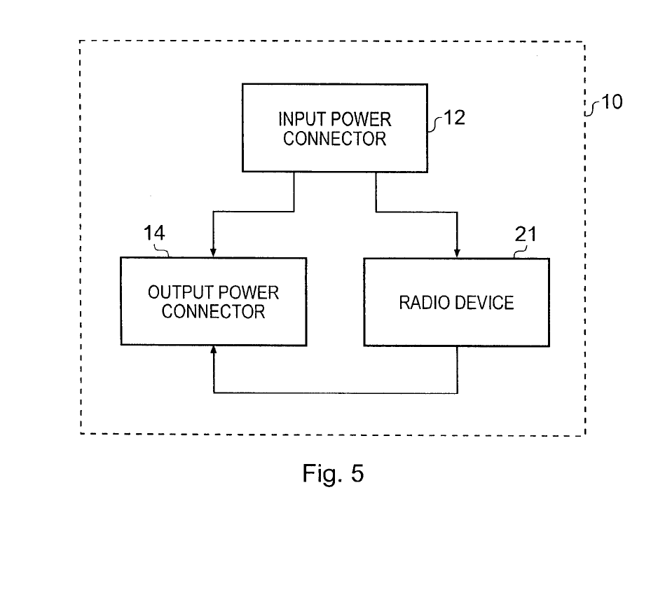

FIG. 5 illustrates an embodiment of the invention in which the apparatus 10 comprises a radio device 21 that is configured to provide an input to the output power connector 14, in order to enable or disable the output power connector 14. It may be that the apparatus 10 comprises a plurality of output power connectors 14, 14′ as in FIG. 3. In such a situation, the radio device 21 may be configured to provide an input to each of the output power connectors 14, 14′ of the apparatus 10.

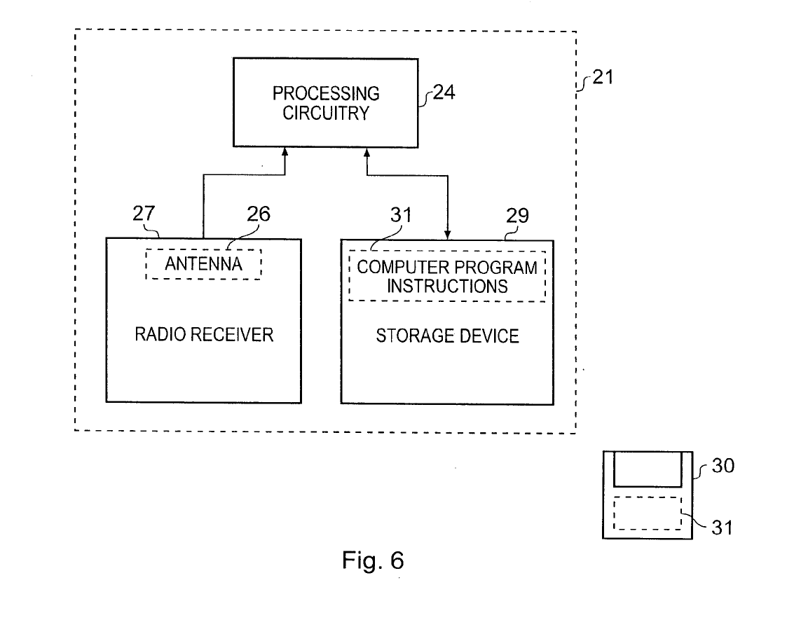

FIG. 6 is a schematic of the radio device 21. The radio device comprises processing circuitry 24, a radio receiver 27 including an antenna 26 and a storage device 29 storing computer program instructions 31.

The embodiment of the radio device 21 illustrated in FIG. 6 may or may not comprise a radio transmitter 25. Where the radio device 21 comprises the radio transmitter 25, the processing circuitry 24 may be configured to perform all of the functions described above in relation to the processing circuitry 24 of FIG. 4. The storage device 29 may also store the data 161 relating to positioning described above.

The processing circuitry 24 of the radio device 21 is configured to determine whether a portable electronic device 300 is in the vicinity of the apparatus 10. For example, the processing circuitry 24 of the radio device 21 may determine that a portable electronic apparatus 300 is in the vicinity of the apparatus 10 by receiving a radio signal from the portable electronic device 300. The processing circuitry 24 may, for example, determine that a portable electronic device is in the vicinity of the apparatus if the received signal strength intensity (RSSI) of the received signal is above a threshold.

In response to the processing circuitry 24 determining that a portable electronic device 300 is in the vicinity of the apparatus 10, the processing circuitry 24 may enable some or all of the output power connectors 14 so that power is distributed to any further apparatuses that are connected to them. If the processing circuitry 24 fails to determine, over a period of time, that a portable electronic device is in the vicinity of the apparatus 10, some or all of the output power connectors 14 may be disabled.

In an alternative implementation, the user may select, at a portable electronic device, which power output connectors 14 are to be enabled and/or disabled. The portable electronic device may then transmit a radio signal to the radio device 21 of the apparatus 10 in order to enable or disable individual power output connectors 14. Additionally, the apparatus 10 may include keys that enable a user to manually enable or disable individual power output connectors 14.

In some embodiments of the invention, a plurality of apparatuses may form an ad-hoc radio network which monitors the position of the portable electronic apparatus 300 in the building 200. In this case, an apparatus 10 may only distribute power to further apparatuses that are connected to it if the position of the portable electronic device 300 is considered to be in the vicinity of the apparatus 10.

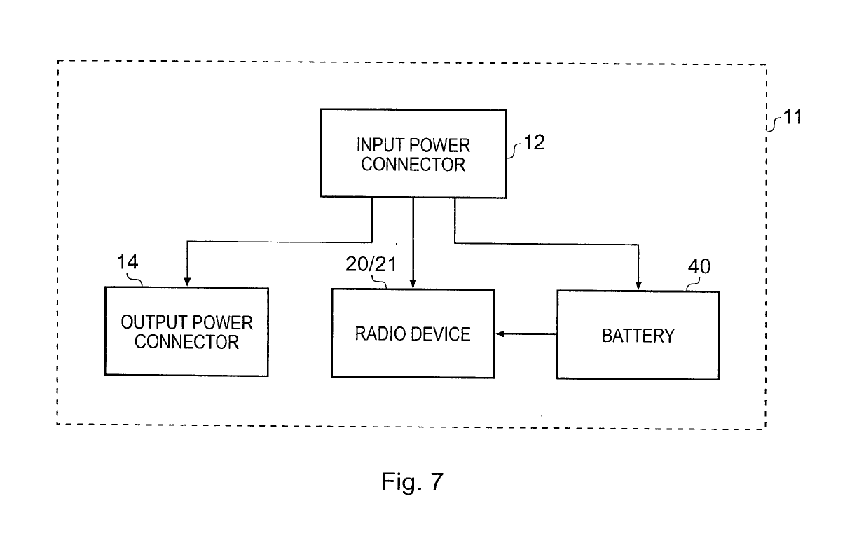

FIG. 7 illustrates another embodiment of an apparatus 11. Any of the apparatus 107-112 illustrated in FIG. 1 may take the form of the apparatus 11 illustrated in FIG. 7. The apparatus 11 is similar to the apparatuses 10 of FIGS. 2, 3 and 5 in that it includes an input power connector 12, an output power connector 14 and a radio device 20/21. The radio device 20/21 is not illustrated in FIG. 7 as providing an input to the output power connector 14. However, it should be appreciated that the radio device 20/21 of FIG. 7 may be configured to provide an input to the output power connector 14 in order to enable or disable it in the manner described in relation to FIGS. 5 and 6.

The apparatus 11 of FIG. 7 differs from the apparatuses 10 of FIGS. 2, 3 and 5 in that it comprises a battery 40. The input power connector 12 distributes electrical power to the battery 40 to charge it. The battery 40 may, for instance, be trickle charged.

When the input power connector 12 is connected to a node 101-106 of the distribution network 150 to receive power from the network 150, it distributes power to the radio device 20/21 to enable the radio device 20/21 to function. However, when the input connector 12 does not receive power from the network 150, power is supplied to the radio device 20/21 by the battery 40.

If the input power connector 12 is connected to a light socket, it may not receive power from the network 150 when a switch associated with the light socket is switched to “off”. In this situation, power may be provided to the radio device 20/21 by the battery 40.

In some embodiments of the invention, the battery 40 may provide power to the radio device 20/21 if the power distribution network 150 does not distribute power to the nodes 101-106 for any reason (for example, if electrical power ceases to be provided to the supply point 114).

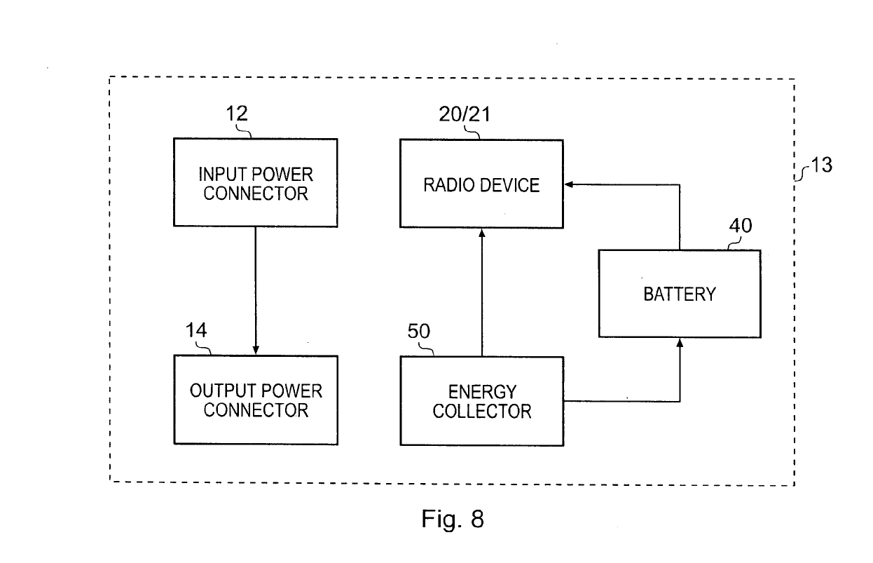

FIG. 8 illustrates another embodiment of an apparatus 13. Any of the apparatus 107-112 illustrated in FIG. 1 may take the form of the apparatus 13 illustrated in FIG. 8. The illustrated apparatus 13 is similar to the apparatuses 10, 11 described in relation to FIGS. 2, 3, 5 and 7 in that it includes an input power connector 12, an output power connector 14 and radio device 20/21. The radio device 20/21 is not illustrated in FIG. 8 as providing an input to the output power connector 14. However, it should be appreciated that the radio device 20/21 of FIG. 8 may provide an input to the output power connector 14 in order to enable or disable it in the manner described in relation to FIG. 5.

The apparatus 13 of FIG. 8 differs from the apparatuses 10, 11 of FIGS. 2, 3, 5 and 7 in that it comprises an energy collector 50. Also, in apparatus 13 shown in FIG. 5, the input power connector 12 and output power connector 14 are optional components.

The energy collector 50 is for collecting energy to charge the battery 40 and/or to power the radio device 20 directly. The energy collector 50 may comprise a photovoltaic device for receiving optical radiation and converting it into electrical current, which is ultimately used to power the radio device 20. The energy collector 50 may comprise a thermionic device for receiving heat and converting it into electrical current, which is ultimately used to power the device 20.

If the apparatus 13 is located close to a lighting element, for example, where the input power connector 12 is coupled to a light socket, heat or light that is output by the lighting element may be collected by the energy collector 50 and used to power the radio device 20. The radio device 20 is indirectly powered by a node 101-106 of the power distribution network 150 because the electrical energy that is output by a node 101-106 is converted into a different form of energy (e.g. heat or light) before being converted back into electrical energy (by the energy collector) to power the radio device 20.

Although embodiments of the present invention have been described in the preceding paragraphs with reference to various examples, it should be appreciated that modifications to the examples given can be made without departing from the scope of the invention as claimed. For example, the building 200 may comprise a network for data exchange. The branches of the data exchange network may be situated close to the branches of the power distribution network 150 and nodes of the data exchange network may be adjacent to the nodes of the power distribution network 150.

In this situation, the apparatus 10, 11, 13 and 107-112 may include a data connector for physical coupling with a data connector at a node of the data exchange network. The data connector may be for receiving data via the data exchange network for configuring the radio device 20. The data connector may be used to receive information that determines how often the radio transmitter transmits radio signals, for example.

In one implementation, the power distribution network 150 may be used to transfer data. In another implementation, the power distribution network 150 may not be used to transfer data.

The data connector may enable an apparatus 10, 11, 13 and 107-112 to be connected to the internet and may enable a user to control the apparatus 10, 11, 13 and 107-112 via the internet. For example, the processing circuitry 24 may be configured to enable or disable some or all of the power output connectors 14, 14′ of an apparatus 10, 11, 13 and 107-112 in response to receiving appropriate data via the internet.

It may be that an ad-hoc radio network is formed by a plurality of apparatuses, and that only one of apparatuses of the ad-hoc radio network is connected to the internet. A user may then control all of the apparatuses in the ad-hoc radio network via the internet and the ad-hoc radio network.

A battery backup may be provided in the system 100 to provide power to the nodes in the event that electrical power ceases to be provided to the supply point 114. The battery backup may comprise a power source at the supply point 114 which distributes power to each of the nodes 101-106. Alternatively or additionally, a separate battery backup may be provided at each of the nodes 101-106.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-27. (canceled)

28. An apparatus, comprising:
an input power connector configured to receive electrical power from an output power connector of a power supply;
an output power connector configured to provide received electrical power to a further apparatus; and
a radio device configured to determine whether an electronic device is in the vicinity of the apparatus, and configured, in response to determining that an electronic device is in the vicinity of the apparatus, to enable the output power connector to provide received electrical power to the further apparatus.

29. An apparatus as claimed in claim 28, wherein the radio device is configured to determine that the electronic device is in the vicinity of the apparatus by receiving a radio signal from the electronic device.

30. An apparatus as claimed in claim 28, wherein the radio device is configured, in response to a failure by the radio device to determine over a period of time that an electronic device is in the vicinity of the apparatus, to disable the output power connector from providing received electrical power to the further apparatus.

31. An apparatus as claimed in claim 28, wherein the radio device is part of a radio network that is used to monitor the position of an electronic device, and the radio device is configured, in response to the position of the electronic device being determined to be in the vicinity of the apparatus, to enable the output power connector to provide received electrical power to the further apparatus.

32. An apparatus as claimed in claim 28, wherein the radio device is configured to receive power from the input power connector.

33. An apparatus as claimed in claim 28, wherein the input power connector of the apparatus is for mating with the output power connector of the power supply.

34. An apparatus as claimed in claim 28, wherein the output power connector of the apparatus is for mating with the input power connector of the further apparatus.

35. An apparatus as claimed in claim 28, wherein the input power connector has a first physical configuration and is configured to couple with an output power connector of a power supply having a second physical configuration, in order to receive electrical power.

36. An apparatus as claimed in claim 35, wherein the output power connector of the apparatus has the second physical configuration.

37. An apparatus as claimed in claim 36, wherein the output power connector of the power supply and the output power connector of the apparatus are receptacles for receiving a lighting element, and the further apparatus is a lighting element.

38. A method, comprising:
determining whether an electronic device is in the vicinity of an apparatus; and enabling, in response to determining that an electronic device is in the vicinity of the apparatus, an output power connector of the apparatus to provide received electrical power to a further apparatus.

39. A method as claimed in claim 38, wherein determining whether an electronic device is in the vicinity of an apparatus comprises receiving a radio signal from the electronic device.

40. A method as claimed in claim 38, further comprising disabling the output power connector from providing received electrical power to the further apparatus, in response to a failure to determine over a period of time that an electronic device is in the vicinity of the apparatus.

41. A method as claimed in claim 38, further comprising: monitoring the position of an electronic device using a radio network, and enabling the output power connector to provide received electrical power to the further apparatus, in response to the position of the electronic device being determined to be in the vicinity of the apparatus.

42. A tangible computer readable medium comprising computer program instructions that, when run by a processor, enable:
determining whether an electronic device is in the vicinity of an apparatus; and providing, in response to determining that an electronic device is in the vicinity of the apparatus, received electrical power to a further apparatus.

43. A tangible computer readable medium as claimed in claim 42, wherein determining whether an electronic device is in the vicinity of an apparatus comprises receiving a radio signal from the electronic device.

44. A tangible computer readable medium as claimed in claim 42, wherein the received electrical power is provided to the further apparatus using an output power connector, and the computer program instructions further enable: disabling the output power connector from providing received electrical power to the further apparatus, in response to a failure to determine over a period of time that the electronic device is in the vicinity of the apparatus.

45. A tangible computer readable medium as claimed in claim 42, wherein the computer program instructions further enable: monitoring the position of an electronic device using a radio network; and providing, in response to the position of the electronic device being determined to be in the vicinity of the apparatus, received electrical power to the further apparatus.

46. An apparatus, comprising:
input power means for receiving electrical power from power output means of a power supply;
output power means for providing received electrical power to a further apparatus; and
radio means for determining whether an electronic device is in the vicinity of the apparatus, and for enabling, in response to determining that an electronic device is in the vicinity of the apparatus, the output power means to provide received electrical power to the further apparatus.
